(19) United States
(12) Patent Application Publication
(10) Pub. No.: US 2012/0255893 A1
(43) Pub. Date: Oct. 11, 2012

(54) Calibrated Chlorinator

(76) Inventor: Gerald Joseph Le Clair, W. Melbourne, NJ (US)

(21) Appl. No.: 13/079,924

(22) Filed: Apr. 5, 2011

(51) Int. Cl. C02F 1/00

(52) U.S. Cl. 210/167.11

(57) ABSTRACT

A dispensing assembly having a first body, herein referred to a float 16 and second body, herein referred to as chlorine reservoir 12, the second body being movably disposed within the cavity of the first body. Float 16, comprising a floatation chamber 26, float cavity 22, ballast weight 10, a plurality of mounting slots 36, a float cap 20 that house mounting tabs 38 which interlock with float 16. Chlorine reservoir 12, comprising a halogen chamber, a column 14 with graduation marks 30, indicator numerals 32, a plurality of ventilation slots 46, flow restrictor 28, to regulate the amount of circulation through reservoir 12 and a removable lower member, a reservoir cap 42 to allow filling reservoir 12 with halogen. The assembly, reservoir 12 residing in float 16, is floated in water which is circulated through the ventilation slots 46 to wet the solid halogen and cause the halogen to dissolve. Controlled water circulation and variable adjustment of the ventilation slots 46 permits the halogen to be dissolved in a precisely controlled manner.

### CROSS REFERENCE TO RELATED APPLICATIONS

None

### FEDERALLY SPONSORED RESEARCH

Not Applicable

### SEQUENCE LISTING

Not Applicable

### BACKGROUND OF THE INVENTION

### Field of the Invention

Unless controlled, the water in swimming pools, spas, hot tubs, and the like can become contaminated with algae and similar organisms. The contaminant growth is usually controlled by the addition of a suitable biocide to the water. Typically, the biocide is a halogen derived from solution of a halogen salt; most commonly the halogen salt is a source of chlorine. The amount of chlorine required to maintain the water in a substantially organism-free state depends on the size of the pool or spa, the climatic conditions, the temperature of the water, and the extent of use of the pool or spa. The hot water found in spas and hot tubs necessitates the frequent addition of chlorine, because the material added rapidly loses effectiveness. A device that can be placed in the water to dispense chlorine in controlled amounts relieves the spa or pool owner or operator of the necessity of regularly monitoring and maintaining the chlorine content of the water.

Chlorine dispensing devices exist for swimming pools. One such device, among many, is the Rainbow Plastics Model 330 floating dispenser for solid chlorine. This dispenser resembles an inverted hollow truncated cone. The interior serves as a receptacle into which granular pellets of water-soluble chlorine source material are placed. Around the circumference of the receptacle adjacent to the bottom there are apertures consisting of elongated vertical slots. The slots cooperate with a similarly slotted sleeve which is captive to and rotatable about the exterior of the container. The sleeve can be adjusted so that the slots are fully closed, fully opened, or in between. The top of the receptacle is closable by a lid which does not make an air-tight seal with the receptacle. The walls of the container are hollow and are filled with closed-cell plastic foam. The cavity in which the foam is located is hermetically sealed. The dispenser does not incorporate any ballast elements.

When filled with a soluble solid source of chlorine or other desired halogen ion source and floated in a swimming pool, the pool water enters into the receptacle and fills it to the level at which the dispenser is floating. The water in the receptacle wets at least that source material which lies below the floating waterline of the dispenser. Accordingly, the wetted source material in the receptacle is dissolved thereby releasing the active constituent of the material into the water in the dispenser. The rate at which such solution is released to the adjacent pool or spa is regulated by the extent to which the apertures in the receptacle are opened or closed by the position of the adjustment sleeve on the exterior of the receptacle. However, this dispenser is not conveniently usable in the comparatively small water volume in a spa because the effective size of the apertures of the dispenser cannot be regulated precisely enough to prevent the dispenser from over-chlorinating the spa water which, by reason of its temperature, acts more rapidly on the source material than the usually cooler water in a swimming pool. Also, this dispenser has a relatively large capacity for containing the source material so that, even when its apertures are very nearly closed, substantial quantities of source material are wetted, dissolved and released from the dispenser.

Another chlorine dispensing device for dispensing a soluble solid source of chlorine i.e., for spas and hot tubs is disclosed in U.S. Pat. No. 4,630,634. Rainbow Plastics Model 335 floating dispenser conforms to the disclosure of that patent. That dispenser comprises a tubular body having a hollow pancake-shaped float at a closed upper end of the body and a tubular-shaped sleeve that fits over the opposite open end of the body. The body accommodates a predetermined volume of soluble solid halogen source material, of which a preselected amount is exposed to contact with the water via a plurality of elongated slots or apertures positioned at diametrically opposite locations in the sleeve. The body and sleeve are threadably engagable with one another to form the assembled dispensing device and are placed in the water in a vertically oriented position with the apertures immersed. The pancake-shaped float at the physical top of the body and a lead weight at the bottom of the sleeve ensures that the dispenser floats vertically erect.

The extent of the solid source material that is wetted is controlled by the axial position of the sleeve on the body. That axial position of the sleeve on the body determines the effective area of the vertical slots in the sleeve which afford communication from the bottom of a chamber in the body and sleeve and in which the source material is contained. Only that portion of the source material that lies below the open end of the body and into the sleeve is exposed to the water to form a biocidal solution. The rate that the solution is dispensed to the water outside the dispenser is controlled by the degree of closure of the apertures. The source material in the chamber above the lower end of the body is dry in the chamber because it lies within an air bubble which is trapped in the interior of the body.

It has been discovered that, in some applications, this latter dispenser does not afford sufficient control over the dispensation rate of the solution from the dispenser. The relatively large openings in the dispenser sleeve can permit the passage of solid chlorine granules from the device to the water where such a highly concentrated oxidizing source can discolor adjacent pool or spa surfaces.

Additionally, once the solid halogen source is completely dissolved, the latter dispenser must be reloaded by disassembling the sleeve from the body and loading the new source material into the body. The need to disassemble the dispenser when reloading it can result in loss of the desired operating position adjustment of the sleeve on the body. An advantage of that latter dispenser over the former one is that, in the latter dispenser, only a small controllable position of the source material is wetted when the filled dispenser is placed into a pool or spa.

Other available products include cumbersome floating structures, which receive a non-refillable disposable replaceable cartridge that contains the soluble source of chlorine or other halogen. The exterior of the cartridge contains ribs which cooperate with slots in a large float to hold the cartridge in a selected position vertically relative to the float. The containers are molded with bumps axially spaced along the container adjacent to the bottom end and a single bump adjacent to the top end. The user cuts off one or more bottom bumps to define the extent to which water communicates with the inside of the container, and cuts off the top bump to provide air communication to the inside of the container. The container is then placed into the large float and the resulting assembly is placed in the pool. Water then fills the cartridge to the water line of the floating assembly; the vertical position of the cartridge in the float determines the extent to which the cartridge contents are wetted.

There are several practical difficulties with these last products. They are quite large and so do not fit well into a spa or hot tub. Their size makes them cumbersome to remove from the spa when the spa is to be used. They are aesthetically unappealing. They cannot reliably be adjusted to provide the precise solution rates needed for efficient chlorination (halogenation) of spas and hot tubs because of the crude and imprecise manner in which communication of water to the interior of the cartridge is provided. They are essentially floating packages of halogen source material designed by major source material manufacturers whose purpose is to market source material; the user cannot change source material without changing the entire dispenser; the user cannot use any source material he wishes.

In a dispenser for spas, it is important that the rate of solution of the source material be controllable with meaningful precision over a range commensurate with the lower chlorination requirements of spas, as compared to swimming pools. It is therefore desirable that a dispensing device afford good control over the rate at which a concentrated biocidal solution is created within the dispenser and over the rate at which that solution is dispensed to the exterior of the device. It is desirable that the dispensing device not be too bulky and not create an obstruction in the spa, and be aesthetically pleasing. The dispensing device should be constructed in a manner facilitating source material reloading without having to disassemble the device or disturb the adjustment for controlling the rate of solution dispensation from the interior of the device. The dispensing device should enable the user to select, as he chooses, from among many commercially available source materials. Finally, the dispensing device should be made of a material resistant to damage from prolonged exposure to sunlight and chemicals.

### Prior Art

TABLE 1
Summary of Prior Art

| Inventor | Patent Number | Date Awarded |
|---|---|---|
| Sasaki, et al. | 4,630,634 | Dec. 23, 1986 |
| Yassin | 6,221,244 | Sep. 11, 2001 |
| Yassin | | Apr. 24, 2001 |
| Enright, et al. | 5,888,386 | Mar. 30, 1999 |
| Rauchwerger | 5,743,287 | Apr. 28, 1998 |
| Price, et al. | 5,476,116 | Dec. 19, 1995 |
| Moini | 5,225,074 | Jul. 6, 1993 |
| Newhard | 5,124,032 | Jun. 23, 1992 |
| Johnson, et al. | 4,691,732 | Sep. 8, 1987 |
| Tighe, et al. | 4,129,493 | Dec. 12, 1978 |
| Phillips | 4,067,808 | Jan. 10, 1978 |

Sasaki, et al discloses a chlorine dispenser for spas includes a tubular container disposed within a sleeve having one closed end. The container and sleeve form a chamber for receiving the solid chlorine source. The sleeve contains apertures for providing access by water to the solid chlorine source. The sleeve is axially movable along the container, and a locknut engages the container to secure a given position of the sleeve. The container is attached to a foam-filled float, which ensures positive buoyancy of the dispenser in water. The sleeve is ballasted to ensure that the dispenser is vertically disposed in the water.

Yassin discloses a pool chlorinator connectable to a water inlet conduit of a swimming pool having a housing with a supply conduit and outlet conduit. The supply conduit terminates with a flexible connector which is adapted to press tightly against the wall surface of the swimming pool and suction cups are employed to mount the housing to the wall of the swimming pool.

Yassin discloses a swimming pool chlorinator that utilizes a cylindrical housing that has an internal chamber. Within the internal chamber is concentrically mounted in a close fitting manner a valve member. The sidewall of the housing has a series of elongated slits and also the valve member has a series of similar elongated slits. The housing has mounted thereon at least one suction cup with the suction cup to be securable to a swimming pool wall surface or other surfaces associated with a swimming pool and beneath the surface of the water in the pool. Within the internal chamber of the housing is located one or more chlorine tablets. The valve member is to be adjusted relative to the housing so that the slits of the housing are unrestricted permitting free flow of water through the housing or the slits are restricted partially thereby limiting the amount of flow of water through the internal chamber. As the water is conducted through the internal chamber, the chlorine tablet is dissolved within the water which chlorinates the water of the swimming pool when this water is conducted exteriorly of the housing.

Enright, et al. discloses a swimming pool skimmer and chlorinator apparatus for use with a conventional pool skimmer system. The swimming pool skimmer and chlorinator apparatus preferably includes an axially bi-sectioned basket member which preferably collects skimmed debris in an upper axial portion and preferably retains water purifying chemicals in a lower axial portion, to generally eliminate incidental direct human contact with the water purifying chemicals. The swimming pool skimmer and chlorinator apparatus also preferably includes a connector to connect the separate axial portions of the bi-sectioned basket member and a security mechanism to generally prevent unintentional separation of the axial portions of the bi-sectioned basket member. The swimming pool skimmer and chlorinator apparatus requires the undertaking of a proactive step, such as disconnecting the security mechanism and separating the axial portions of the bi-sectioned basket member, to access the portion of the bi-sectioned basket member which may contain the water purifying chemicals.

Rauchwerger discloses a swimming pool chlorinator has a flow pipe that is removably attached to the inlet jet pipe from the pool circulation system and a container for chlorine-containing tablets that is located above the flow pipe. The chlorinator is submerged and the container has an opening to allow water from the pool to flow into the container and dissolve the tablets. A duct from the bottom of the container leads to the interior of the flow pipe. The duct extends into the flow pipe to constrict the flow through the pipe, so that this flow causes chlorinated solution to be aspirated from the container into the flow by means of the Venturi effect. The container is transparent so that the chlorine tablets are visible from outside the container. The container further has a removable lid for refilling the container. The container opening comprises a slotted hole in the lid, with a sliding plate that can be moved over this slot to vary the size of the opening and thereby regulate the flow through the container. The flow pipe has a knurled end that is inserted in the inlet jet pipe, so that the inlet jet pipe supports the chlorinator and the entire assembly may be removed from the pool for refilling.

Price, et al. discloses a dispensing device comprising a body having a chamber sized to accommodate a volume of solid halogen source therein. The chamber comprises an open end and a closed end. A number of apertures extend through the body and into the chamber near the closed end. A control member comprises an open end and a closed end separated by a wall. The open end of the control member is rotatably mounted over the closed end of the chamber. Openings extend through the wall and are positioned at locations that correspond to the apertures so that alignment of the openings with respective apertures form dispensement ports. The ports has a degree of closure that can be precisely controlled by rotation of the control member about the body for dispensing the halogen solution to the water. A cap is releasably attached to the open end of the chamber to form an air and water-tight seal there between, creating an air head within the body when placed into the water. The air head controls the amount of solid halogen source wetted to that portion adjacent the apertures. Water is circulated through the apertures to wet the solid source and generate halogen solution. Controlled solid source wetting and variable adjustment of the dispensement ports permits halogen solution to be dispensed in the water in a precisely controlled manner.

Moini discloses an automatic swimming pool chlorinator having a submersible canister for receiving and containing chlorine tablets or sticks. The canister, at its upper end, is provided with a separable lid which includes: a principal water flow conduit through which pool water is recirculated by suction to the pool's water filter and heater system or returned to the pool via a water return line; a multiplicity of small ports for admitting relatively small quantities of pool water to the canister to dissolve the chlorine therein over a period of time; a chlorinated water flow channel leading from the canister to the principal water flow conduit and through which chlorinated pool water is aspirated from the canister, and is mixed with, the flow of recirculated pool water in the principal water flow conduit; and a water flow controller located within the chlorinated water flow channel to control the amount of chlorinated water aspirated from the canister and through such channel by the pool water being recirculated through the principal water flow conduit to the pool's filter and heater system. The chlorinator may be mounted between sections of the water suction hose line leading from a pool cleaner unit to a pool skimmer. Alternatively, the chlorinator may be mounted at one end of its principal water flow conduit directly to a water recirculation return line at the side of the pool.

Newhard discloses a chemical treatment device, i.e., a chlorinator, for use in a swimming pool filtration and circulation system having a skimmer system with a water intake from the pool, a filter for receiving and filtering water taken in, and a pump for returning filtered water to the pool. The device has a vessel of synthetic material with a compartment for treatment chemical, and is provided with an array of break-opens at different levels for opening through from exteriorly of the vessel into the compartment. The device includes an arrangement for locating the vessel to receive flow of water entering the skimmer causing flow to be exposed to the chemical for dissolving it. Interior walls of the compartment diverge downwardly to prevent bridging of the chemical within the compartment. The compartment has a drain for discharging treated water into the skimmer system. Discharging may also take place through the break-opens.

Johnson, et al. discloses a device for dispensing a chemical wherein a stack of dry chemical tablets are contained within a receptacle. Sealing means are provided to seal around each tablet and the inner wall of the canister so that only the upper surface of the top tablet is exposed to the circulating water. The tablets are not exposed to the flowing water until the tablets above have been eroded away successively to provide leak paths around them.

Tighe, et al. discloses a new and improved swimming pool chlorinator which facilitates the provision of a higher strength hypochlorite solution over a wide concentration range than can be obtained from prior swimming pool chlorinators. The new and improved chlorinator utilizes a membrane type cell having opposed catholyte and anolyte chambers including a cathode and an anode member, respectively, disposed in a close spaced relationship to each other and separated by a substantially hydraulically impermeable cation exchange membrane. The products of electrolysis in the catholyte and anolyte chambers are combined exteriorally of the cell to obtain sodium hypochlorite which may then be conveyed to the swimming pool water. Means are provided to selectively vary the electrical current in the cell to control the amount of sodium hydrochlorite ultimately produced.

Phillips discloses a chlorinator for a swimming pool with a recirculation system that includes a container to hold a column of chlorine concentrate solution, and a pool water supply conduit with a flow regulator connected to a return conduit of the recirculation system. Some of the pool water is caused to slowly flow into the container forming a gradually increasing column of pool water above the chlorine concentrate solution inside the container. A layer of separating material, having a specific gravity between that of pool water and that of the chlorine concentrate solution, rests on the bottom of the pool water in the container and floats on top of the column of the chlorine concentrate solution, and effectively prevents mixing of these two liquids. The gradually increasing column of pool water in the container then gradually forces the chlorine concentrate solution out of the container through another supply conduit to a height between the top and bottom of the container. A feeder member, connected to the return conduit and positioned below the output of the chlorine concentrate supply conduit, receives the chlorine concentrate solution from this supply conduit to add it to the pool water returning to the swimming pool.

### Objects and Advantages

Objects and advantages of the present invention are to:
Provide a chlorinator that uses a physical indicator to automatically reveal the amount of chlorine remaining in the reservoir
Provide an automatic chlorinator that is freely floating to randomly distribute chlorine in the pool
Provide a chlorinator with sail to randomly float about a pool according to variable breezes and thereby disburse chlorine in a nearly even fashion.

### SUMMARY

In accordance with the present invention, a floating pool chlorinator having an analog indicator showing the amount of chlorine available in the chlorinator.

### DETAILED DESCRIPTION

### Figures

FIG. 1—Exploded View of chlorinator

FIG. 2—View of chlorinator at full capacity

FIG. 3—View of chlorinator with one tablet left

### DRAWINGS

### Reference Numerals

10 Ballast Weight
12 Chlorine reservoir
14 Column
16 Float
18 Float Base
20 Float cap
22 Float cavity
24 Float neck
26 Floatation chamber
28 Flow Restrictor
30 Graduation marks
32 Indicator numerals—chlorine quantity
34 Low quantity indicator
36 Mounting slot
38 Mounting tab
40 Quantity indicator
42 Reservoir Cap
44 Rib
46 Ventilation slot

### Preferred Embodiment

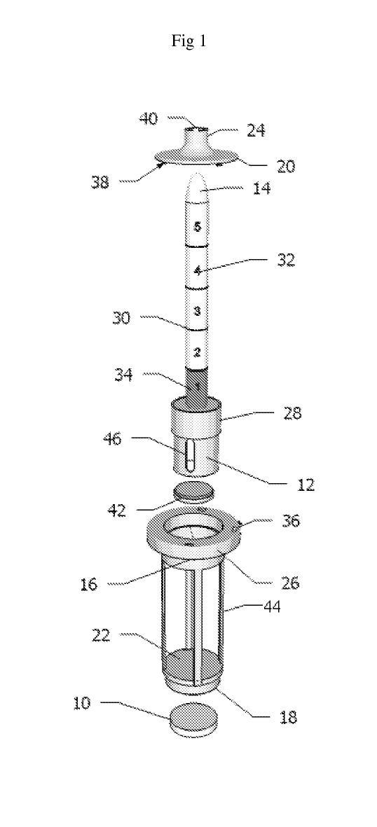

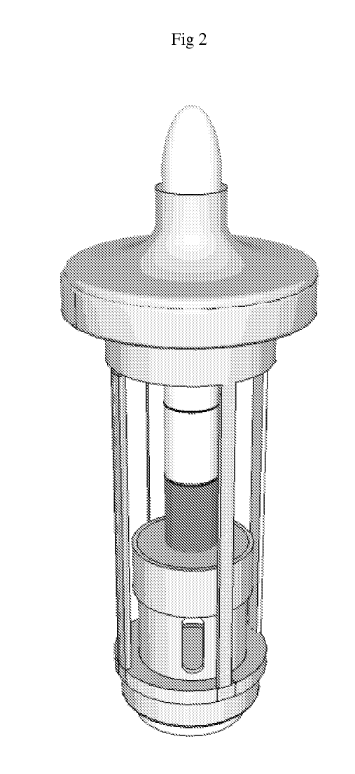

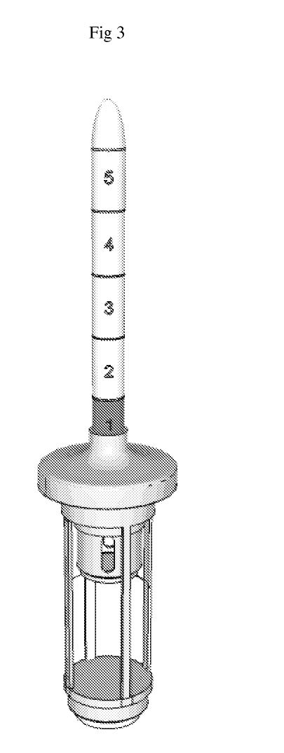

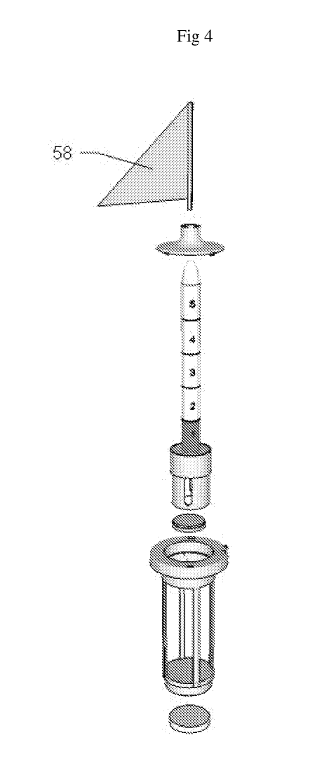

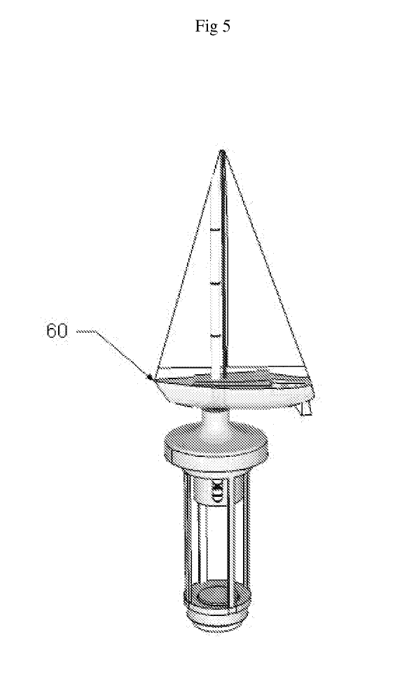

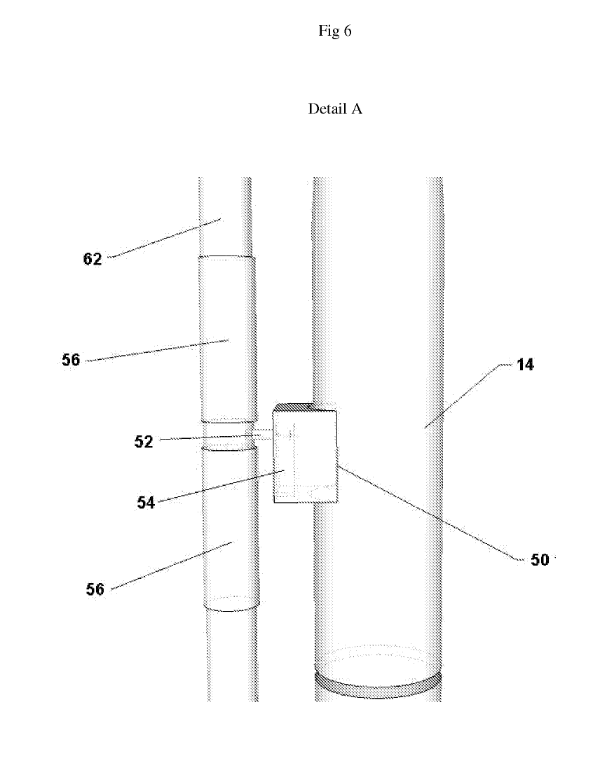

### FIGS. 1 Through 3

A preferred embodiment of the present invention is given in FIG. 1. In operation, chlorine reservoir 12 resides inside float 16.

Chlorine reservoir 12 is formed by injection molding and has two dissimilar columns joined at the intersection of reservoir 12 and column 14. Reservoir 12 is a void enclosed by removable reservoir cap 42. Disposed along its outer wall are a plurality of ventilation slots 46. The lower end of reservoir 12 has a threaded opening to receive reservoir cap 42. Column 14 is a hollow tube tapered on the first end to form a nose cone and displaying a plurality of horizontal lines between which are indicator numerals. The lowest segment is a different color indicating low quantity and is referred to as low quantity indicator 40. Column 14 is fixedly joined on its second end to chlorine reservoir 12. Indicator numerals 32 are disposed evenly along column 14 to indicate the number of tabs remaining within the reservoir 12 cavity. Flow restrictor 28 is an outer cylinder with a plurality of ventilation slots 46 mounted by friction fit to reservoir 12 and movable to adjust the dissolution rate of halogen in the cavity of reservoir 12.

Float 16 consists of floatation chamber 26, a plurality of ribs 44, float base 18 and ballast weight 10. Float 16 is made from an injected molded polymer. Floatation chamber 26 has on it's first end an opening to receive reservoir 12 and on its second end, a structure that supports a plurality of ribs 44. Ribs 44 are evenly disposed (every ninety degrees) around the circumference of float 16. The lower end of ribs 44 transition to float base 18 which is an integral part of float 16. The combination of chamber 26, ribs 44 and base 18 form float cavity 22 within which reservoir 12 is held captive within two degrees of motion (lateral x and lateral y). Reservoir 12 is allowed freedom to travel in the vertical direction. Float 16 is open at the top until float cap 20 is removably attached. Float cap 20 is a disk that has been extruded along the vertical axis to form a gradually decreasing truncated tube referred to as float neck 24. Around the outer lower circumference of float cap 20, there is a plurality of evenly disposed projections referred to as mating tabs 38. Disposed on the upper surface of cap 20 is float neck 24 whose diameter is parallel to the diameter of the base of cap 20. Float cap 20 encompasses column 14 when affixed to float 16. A quantity indicator 40 in the form of a small protrusion is disposed at the top of float neck 24.

### Operation

The user may operate “Calibrated Chlorinator” in the following manner:
1. Remove float cap 20 from float 16.
2. Remove chlorine reservoir 12 from float 16.
3. Remove reservoir cap 42 from reservoir 12
4. Install the recommended number of chlorine tabs for the pool in use into reservoir 12
5. Re-attach cap 42 to reservoir 12
6. Adjust flow restrictor 28 on reservoir 12 to a position that results in the desired rate of dispersion. Make note of restrictor 28 position on reservoir 12 and the number of tabs installed.
7. Float Calibrated Chlorinator in the pool
8. Verify the number of tabs on quantity indicator 40 equals the number of tabs loaded into reservoir 12. This is only required once for each type of tab used.
9. When low quantity indicator 34 shows, take note of quantity remaining and adjust restrictor 28 as necessary.

### Additional Embodiments

There are two additional embodiments; the first adds sail 58 to the top of column 14. Sail 58 is both decorative and catches breezes that randomly push the chlorinator around the pool to aid in the even distribution of chlorine. The second embodiment mates column 14 to a mechanical arrangement that connects column 14 to sailboat 60. The mechanical arrangement is shown as Detail A and is comprised of column catch 50, catch pin 52, catch slot 54, clasp 56, sailboat 60 and sail lanyard 62. By connecting column 14 to sail lanyard 62, sail 58 is lowered as column 14 rises in response to the decreasing weight of chlorine in reservoir 12. When reservoir 12 is refilled, it rides lower in the water. Sail 58 is manually raised and catch pin 52 is joined with catch slot 54 to repeat the process. The concept is simple and intuitive—full reservoir 14, full sail 58, empty reservoir 14, no (lowered) sail 58.

### DETAILED DESCRIPTION

### FIGS. 4 Through 6

FIG. 4—Chlorinator with first additional embodiment—sail

FIG. 5—Chlorinator with second additional embodiment—sailboat

FIG. 6—Detail A—Sail lanyard to column catch design

### DRAWINGS

### Reference Numerals

50 Column catch
52 Catch pin
54 Catch slot
56 Clasp
58 Sail
60 Sailboat
62 Sail lanyard

### Alternative Embodiments

### None

### Advantages

Advantages of Calibrated Chlorinator are as follows:
1. Provides a visual indication of the amount of chlorine remaining in the reservoir in equivalent tabs (i.e. six tabs halfway dissolved equates to three full tabs)
2. Provides a means for keeping the pool properly chlorinated by giving an immediate indication of the quantity of chlorine being dispensed
3. Provides a means for economizing on chlorine use by providing a constant rate of chlorine dissolution.
4. Enhances the even distribution of chlorine by taking advantage of variable winds that are caught in the sail to randomly move the chlorinator around the pool.

### CONCLUSIONS, RAMIFICATIONS AND SCOPE

Calibrated Chlorinator offers these distinct advantages over present day floating chlorinators:
Quantity remaining from a distant glance. Present floating chlorinators are of two types, those that are simply reservoir's and require the user to physically retrieve the chlorinator and remove the lid to view the remaining contents and those that pop the lid when empty. Simple floating reservoirs require unnecessary labor each time it is desired to determine the quantity. The user must approach the pool, snare the chlorinator and remove the top to get an indication of quantity remaining. The Pop-up type gives an indication only when the reservoir is completely empty. In many cases, there will be a period of time when the quantity is insufficient to properly chlorinate the pool and water quality will begin to degrade before the lid pops. Calibrated Chlorinator provides a constant reading of the quantity remaining. The user will soon learn when it is time to refresh the quantity. For instance, he may determine that when two tablets are remaining it is time to top off with two more. In this manner he keeps a more nearly constant concentration of chlorine in the pool and avoids a deficit situation where the water starts to cloud or algae can gain a foothold.
In the first alternative embodiment, a sail is affixed to the quantity mast to allow random breezes to push the chlorinator around the pool and create a more even distribution
In the second alternative embodiment, a toy sailboat is disposed over the chlorinator and the indicator column becomes the mast for the sail. Through a simple mechanical arrangement, the indicator column level is tied to the sail. When the chlorinator is full the sail is up—when the chlorinator is empty, the sail is down. Again the quantity is visible from a distance such as inside the home or from a comfortable position on the pool deck only now the sailboat adds a degree of originality, creativity and perhaps mild amusement. Again, the sail causes random motion which makes for more even distribution.
An additional advantage of floating chlorinators is that they dispense around the clock and do not require the pool pump to be on.
Calibrated Chlorinator may be used in any pool where normal chlorination is recommended for water purification and control of algae.
Operation is simple and straightforward. The user removes the reservoir from the float then removes the cap from the reservoir and fills the reservoir with chlorine tabs. The cap is replaced, the reservoir is placed into the float and the float cap attached. The assembly is ready to be returned to the pool to maintain chlorination

I claim:

1. An apparatus for dispensing halogen while floating in water, comprising a two part assembly, the first assembly herein referred to as the float, and a second assembly, herein referred to as the reservoir,
a. In accordance with claim 1;
i. A float, generally cylindrical in shape, with an oversized disk shaped cylinder on the first end, said cylinder having a removable cap on the first end and having a plurality of recesses evenly disposed around the top face of said cylinder, said cylinder further having a void in the center, said void extending along the long axis of said float to the second end of said float herein referred to as a base, said cylinder further having a partition around a circumference to form a cavity herein referred to as a buoyancy chamber, said cylinder further having disposed between said buoyancy chamber and said base, a plurality of thin rectangular columns herein referred to as ribs evenly disposed around the inner circumference of said float, said base further containing a mass herein referred to as a ballast weight, said weight being sufficient to cause said float to maintain vertical stability under all loading conditions and under all wind conditions in the event of the addition of the first or second embodiment
ii. A removable end piece herein referred to as the float screw cap being generally circular in shape, having a plurality of L-shaped projection on the first end to mate with said float and on the second end, a protruding hollow column, said column being formed by a smooth transition from the top face of said cap to form a circular opening of smaller diameter whose diameter is parallel to the diameter of said cap and further having a projection herein referred to as the level indicator on the face of the first end of said cap.
b. In accordance with claim 1;
i. A reservoir comprising three members, a first cylinder, a second cylinder herein referred to as the flow restrictor and a third detachable member herein referred to as the reservoir screw cap.
ii. A first cylinder, having a hollow column on the first end and a hollow compartment on the second end, said column having markings calibrated in discrete quantities of chlorine (tabs) and having a dome shape on the first end and fixedly joined on the second end to said hollow chamber. A hollow chamber being fixedly joined on its first end to said column and having two openings herein referred to as ventilation apertures, said apertures allowing for the circulation of water through the interior of said hollow compartment and further having a threaded opening on the second end.
iii. A second cylinder, herein referred to as a flow restrictor, being hollow within and being movably disposed over said first cylinder
iv. A threaded member previously referred to as the reservoir screw cap, said cap being disc shaped with external threads and being removably joined to said first cylinder.
